(19) United States
(12) Patent Application Publication
(10) Pub. No.: US 2004/0207346 A1
(43) Pub. Date: Oct. 21, 2004

(54) Linear motor comprising an improved function approximator in the controlling system

(76) Inventors: Theodorus Jacobus Adrianus De Vries, Enschede (NL); Bastiaan Johannes De Kruif, Enschede (NL)

Correspondence Address: JENSEN + PUNTIGAM, P.S., SUITE 1020, 2033 6TH AVE, SEATTLE, WA, 98121, US

(21) Appl. No.: 10/482,765

(22) PCT Filed: Jun. 25, 2002
(86) PCT No.: PCT/NL02/00421

(30) Foreign Application Priority Data
Jun. 26, 2001 (NL) 1018387

(51) Int. Cl. H02P 1/00; H02P 3/00; H02P 5/00

(52) U.S. Cl. 318/114

(57) ABSTRACT

The invention relates to a linear motor with a control system for the translator which is provided with a function-approximator for approximating a function related to the movement of the translator for the purpose of determining the control signal. The function-approximator operates in accordance with the “Support Vector Machine” principle.

The invention further relates to a method for controlling a translator of a linear motor which is provided with a control system comprising a function-approximator, with the following steps of:

a) Approximating a function related to the movement of the components by means of the function-approximator;

b) Determining a control signal for the translator on the basis of the function approximated in step a); and

c) Applying the “Support Vector Machine” principle in the function-approximator.

The invention further describes a control system for applying in this linear motor and a computer program for performing this method.

The present invention relates to the field of linear motors. The invention relates particularly to a linear motor with a control system provided with a function-approximator.

A control system of a linear motor generally comprises a feed-back controller to allow compensation for stochastic disturbances. In addition, such a control system usually comprises a feed-forward controller, which can be implemented as a function-approximator, for the purpose of compensating the reproducible disturbances.

An example of a function-approximator known in the field is the so-called B-spline neural network. This function-approximator has the significant drawback that it functions poorly if the function for approximating depends on multiple variables. This is because the number of weights in the network grows exponentially with the number of input variables. As a consequence the generalizing capability of the function-approximator hereby decreases. In addition, high demands are made of the available memory capacity. It is evident that the approximation process is made even more difficult by the large number of weights. These drawbacks are known in the field as the “curse of dimensionality”.

It is an object of the present invention to provide a linear motor with a control system that is provided with a function-approximator which obviates these drawbacks.

The present invention provides for this purpose a linear motor with a control system for controlling one or more components of the linear motor movable along a path, wherein the control system is provided with a function-approximator which is adapted to approximate one or more functions related to the movement of the components for the purpose of determining at least a part of a control signal, wherein the function-approximator operates in accordance with the “Support Vector Machine” principle.

Application of the per se known mathematical principle of the “Support Vector Machine” provides as solution only those vectors of which the weights do not equal zero, i.e. the support vectors. The number of support vectors does not grow exponentially with the dimension of the input space. This results in a considerable increase in the generalization capability of the linear motor according to the invention. In addition, the required memory capacity is smaller since it now no longer depends on this dimension, but on the complexity of the function for approximating and the selected kernel-function.

In a first preferred embodiment of the linear motor according to the invention the function-approximator further operates in accordance with the least squares principle. A quadratic cost function is now introduced in effective manner. This results in a linear optimization problem which makes fewer demands on the computer hardware for the solving thereof, particularly in respect of the speed and the available memory capacity.

According to a second preferred embodiment of the linear motor of the invention the function-approximator operates in accordance with an iterative principle. By applying an iterative version of the “Support Vector Machine” principle the function-approximator can perform the required calculations on-line. Preceding data concerning the path to be followed, which is normally obtained from a training session, is no longer necessary for this purpose. This has the important advantage that the linear motor according to this second preferred embodiment can be immediately operative without prior repetitive training movements over the path to be followed being required.

According to a further preferred embodiment of the linear motor of the invention a dataset with initial values to be inputted into the function-approximator comprises a minimal number of data, which partially represents the movement of the movable components for controlling. One initial data value is in principle sufficient. In practice, successful operation will be possible with a handful of, for instance five to ten, initial data values.

The invention likewise relates to a method for controlling one or more components of a linear motor movable along a path, which motor is provided with a control system comprising a function-approximator, which method comprises the following steps of: a) approximating one or more functions related to the movement of the components by means of the function-approximator; b) determining at least a part of a control signal for the movable components on the basis of the function approximated in step a); and c) applying the “Support Vector Machine” principle in the function-approximator.

In a first preferred embodiment of the method according to the invention the method further comprises the step of applying the least squares principle in the function-approximator.

In a second preferred embodiment of the method according to the invention the method further comprises the step of having the function-approximator function iteratively.

In a further preferred embodiment of the method according to the invention the method further comprises the step of feeding to the function-approximator a dataset with initial values which comprises a minimal number of data partially representing the movement of the components for controlling.

The present invention also relates to a control system for applying in a linear motor according to the invention.

The present invention further relates to a computer program for performing the method according to the invention.

The invention will now be discussed in more detail with reference to the drawings, in which

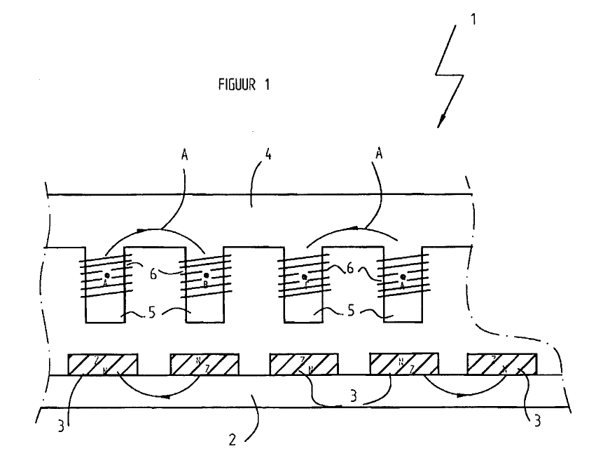

FIG. 1 shows schematically a part of a linear motor in cross-sectional view; and

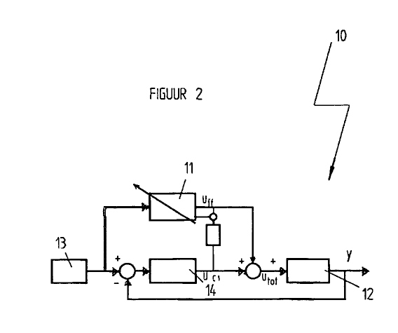

FIG. 2 shows a diagram illustrating the operation of a control system with function-approximator in the linear motor of FIG. 1.

FIG. 1 shows a linear motor 1 comprising a base plate 2 with permanent magnets 3. A movable component 4, designated hereinbelow as translator, is arranged above base plate 2 and comprises cores 5 of magnetizable material which are wrapped with electric coils 6. Sending a current through the coils of the translator results in a series of attractive and repulsive forces between the poles 5,6 and permanent magnets 3, which are indicated by means of lines A. As a consequence hereof a relative movement takes place between the translator and the base plate.

The movement of the translator in the linear motor is generally subjected to a number of reproducible disturbances which influence the operation of the linear motor. An important disturbance is the phenomenon of “cogging”. Cogging is a term known in the field for the strong interaction between permanent magnets 3 and cores 5, which results in the translator being aligned in specific advanced positions. Research has shown that this force depends on the relative position of the translator relative to the magnets. The movement of coils 6 through the electromagnetic field will of course further generate a counteracting electromagnetic force. Another significant disturbance is caused by the mechanical friction encountered by the translator during movement. So as to ensure the precision of the linear motor the control system must compensate these disturbances as far as possible.

FIG. 2 shows schematically the operation in general of a control system 10 with function-approximator 11 for a linear motor 12.

Reference generator 13 generates a reference signal to both function-approximator 11 and control unit 14. The output signal y of linear motor 12 is compared to the reference signal in a feed-back control loop. Control unit 14 generates a control signal u_{c} on the basis of the result of the comparison.

Reference generator 13 also generates a reference signal to function-approximator 11. In addition, function-approximator 11 receives the control signal u_{c}. By means of this information the function-approximator 11 learns the relation between the reference signal and the feed-forward control signal u_{ff} to be generated. This output signal u_{ff} of function-approximator 11 forms together with the control signal u_{c} of control unit 14 the total control signal for linear motor 12.

The combination of a feed-back and a feed-forward shown in the diagram is known in the field as Feedback Error Learning, see for instance the article “A hierarchical neural network model for control and learning of voluntary movement” by Kawato et al., in Biological Cybernetics, 57:169-187, 1987.

According to the invention the function-approximator operates in accordance with the principle of the “support vector machine” (SVM). This principle of the “support vector machine” is known in the field of mathematics and is discussed for instance in “The Nature of Statistical Learning Theory”, Vapnik, V. N., Springer-Verlag 2^{nd} edition (2000), New York. This principle will not be discussed extensively in this patent application. A short summary will serve instead which will be sufficiently clear to the skilled person as illustration of the present invention.

According to the proposed SVM principle a ε-insensitivity function is introduced as cost function. This function is given below:

$${\vert y - f ( x ; w ) \vert}_{ε} = \{ \begin{matrix}0 , & if \vert y - f ( x ; w ) \vert < ε \\ \vert y - f ( x ; w ) \vert - ε & otherwise\end{matrix}$$

Here ε≧0 is the absolute error that is tolerated.

The minimization of this cost function for a dataset with I values using Lagrangian optimization theory results in the following minimization problem:

$$\begin{matrix}W ( α , {α}^{*} ) = {\sum }_{i = 1}^{l} - ε ( {α}_{i} + {α}_{i}^{*} ) + {\sum }_{i = 1}^{l} {y}_{i} ( {α}_{i}^{*} - {α}_{i} ) - \\ {\sum }_{i , j = 1}^{l} \frac{1}{2} ( {α}_{i}^{*} - {α}_{i} ) ( {α}_{j}^{*} - {α}_{j} ) k ( {x}_{i} , {x}_{j} )\end{matrix}$$

with the constraints:

$$\begin{matrix}{\sum }_{i = 1}^{l} {α}_{i}^{*} = {\sum }_{i = 1}^{l} {α}_{i} & \\ 0 \leq {α}_{i}^{*} \leq C , & i = 1 , … , l . \\ 0 \leq {α}_{i} \leq C , & i = 1 , … , l .\end{matrix}$$

In this equation the α^{(*)}'s are the Lagrangian multipliers. yᵢ is the target value for example i. k(xᵢ,xⱼ) is kernel function which represents an inner product in a random space of two input vectors from the examples. The C is an equalization parameter.

The output data values of the function-approximator are given by

$$f ( x , {x}_{i} ) = {\sum }_{SV} ( {α}_{i}^{*} - {α}_{i} ) k ( x , {x}_{i} ) .$$

In this equation the sum is taken over the support vectors (SV). Owing to the ε-insensitivity cost function, only a few values of a do not equal zero. This follows from the Karush-Kuhn-Tucker-theorem and this results in a minimal or sparse solution.

The use of SVM as function-approximator has the following significant advantages. The SVM function-approximator requires less memory space than other function-approximators known in the field, such as “B-spline” networks. The solution to the minimization problem provides only those vectors with weights not equal to zero, i.e. the support vectors. In contrast to the stated “B-spline” networks, the number of support vectors required does not grow exponentially with the dimension of the input space. The number of required support vectors depends on the complexity of the function to be approximated and the selected Kernel-function, which is acceptable. Since the optimization problem is a convex quadratic problem, the system cannot further be trapped in a local minimum. In addition, SVMs have excellent generalization properties. The equalization parameter C moreover provides the option of influencing the equalization or smoothness of the input-output relation.

Application of SVMs as function-approximator demands a large computational capability of the hardware in the linear motor. This computational load can be sub-divided into two parts: the load for calculating the output data values and the load for updating the approximator. The output data values of the network are given by:

$$f ( x , {x}_{i} ) = {\sum }_{SV} ( {α}_{i}^{*} - {α}_{i} ) k ( x , {x}_{i} ) .$$

In this first preferred embodiment the function is approximated in its entirety. The linear motor can hereby be trained in excellent manner off-line. In this case it is after all possible to influence the movements the system makes, and a path can be defined characterizing the input space. However, in order to be able to deal with time-dependent systems, an on-line training, i.e. during performance of the regular task of the linear motor, is required. The invention also has the object of providing a linear motor with improved function-approximator which is suitable for this purpose.

According to a second preferred embodiment of the linear motor of the invention the SVM function-approximator operates in accordance with the least squares principle. This principle is per se known in the field of mathematics and is described for instance in “Sparse approximation using least squares support vector machines” by Suykens et al, in “IEEE International Symposium on Circuits and Systems ISCAS '2000”. In the context of this patent application a short summary will therefore suffice related to the intended application, viz. for controlling a linear motor. This summary is sufficiently clear for a skilled person in the field.

The difference between the second and the first preferred embodiment lies generally in the use of a respective quadratic cost function instead of a ε-insensitive cost function. This results in a linear optimization problem which is easier to solve. A sparse representation can be obtained by omitting the vectors with the smallest absolute α. This is designated in the field of neural networks with the term “pruning”. The vectors with the smallest absolute α contain the least information and can be removed while causing only a small increase in the approximation error. The growth of the approximation error (for instance I₂ and I_{∞}) can be used to determine when the omission of vectors must stop.

The SVM in accordance with the least squares principle operates as follows. In order to approximate a non-linear function the input space is projected onto a feature space of higher dimension. A linear approximation is carried out in this feature space. Another method of representing the output data values is therefore:

y(x)=w^{T}φ(x)+b

wherein the w is a vector of weights in the feature space and the φ is a projection onto the feature space. The b is the constant value to be added, also designated as “bias”. In the SVM in accordance with the least squares principle the optimization problem is formulated as follows:

$${min}_{w , e} I ( w , e ) = \frac{1}{2} {w}^{T} w + γ {\sum }_{k = 1}^{N} {e}_{k}^{2}$$

This is subject to the equality constraints:

yₖ=w^{T}φ(xₖ)+b+eₖ. k=1, . . . , N

The Lagrangian is used to formulate this optimization problem:

$$ℒ ( w , b , e \text{:} α ) = I ( w , e ) - {\sum }_{i = 1}^{N} {α}_{k} ( {w}^{T} φ ( {x}_{k} ) + b + {e}_{k} - {y}_{k} )$$

The required conditions are:

$$\{ \begin{matrix}\frac{\partial ℒ}{\partial w} = 0 & -> & w = {\sum }_{i = 1}^{N} {α}_{i} φ ( {x}_{i} ) \\ \frac{\partial ℒ}{\partial b} = 0 & -> & {\sum }_{i = 1}^{N} {α}_{i} = 0 \\ \frac{\partial ℒ}{\partial {e}_{k}} = 0 & -> & w = {α}_{i} = γ {e}_{k} \\ \frac{\partial ℒ}{\partial {α}_{k}} = 0 & -> & {w}^{T} φ ( {x}_{k} ) + b + {e}_{k} - {y}_{k} = 0\end{matrix}$$

After elimination of eₖ and w, the solution is given by:

$$[ \begin{matrix}0 & {\vec{1}}^{T} \\ \vec{1} & Ω + {γ}^{- 1} I\end{matrix} ] [ \frac{b}{α} ] = [ \frac{0}{y} ]$$

In this equation y=[y₁; . . . ; y_{N}], vector 1=[1; . . . ; 1], α=[α₁; . . . ; α_{N}]. The matrix Ω is given by Ω_{i,j}=k(xᵢ,xⱼ). This matrix is symmetric positive definite. This follows from Mercers Theorem.

A significant advantage of the second preferred embodiment is that the computational load is greatly reduced, which accelerates performing of the calculations considerably. The problem has after all been changed from a quadratic optimization problem to a linear system of equations. A drawback associated with this is that while the problem has become linear, the sparseness is reduced, with the result that the problem has to be solved repeatedly. This takes extra time.

According to a third preferred embodiment of the linear motor of the present invention the SVM function-approximator operates in accordance with the least squares principle and in accordance with an iterative principle. This has the important advantage that it is no longer necessary to wait until all data is available, but that the calculations can start as soon as the first data value is available. This means that special training movements or a training period are no longer required. In contrast hereto, the linear motor can learn during operation. This has the important advantage that the linear motor can allow for time-variant behaviour which may for instance occur due to friction.

Instead of searching for data values with the least information and removing these in the subsequent training, the data value with the least information can be excluded in each iteration. This can give a different solution from that where removal takes place at the end. It may occur that a data value is now removed which can later provide information. Since the motor will be at the same point some time later, this data value will still be included later.

The third preferred embodiment starts with a minimal amount of data values. The set of initial values may contain only one data value, or a number of data values, for instance a handful; in practice a set of initial data values will contain for instance five or ten data values, and be increased by for instance one value at a time. When the set of data values is increased, the following steps generally have to be performed:

(1) Add a column and a row to the Ω in respect of the new data value.

(2) Update the Cholevsky-decomposition.

(3) Calculate the new α's and bias.

(4) Determine whether data values can be removed.

(5) Update the Cholevsky-decomposition.

The above stated steps will be described in more detail below.

1. Renew Ω

This step proceeds via the formula:

$${Ω}_{k + 1} = [ \begin{matrix}{Ω}_{k} & {Ω}_{k} \\ {Ω}_{k} & {Ω}_{k}\end{matrix} ]$$

Here ω is a column vector with the inner product in the feature space between the new data value and the old data values. The o is the inner product in the feature value of the new data value with itself. The γ is a regularization parameter.

It is noted that this step will not generally be performed in the memory of the computer because it is advantageous to operate directly with the decomposition.

Step 2 Update Cholevsky

Here Rₖ is the Cholevsky decomposition of the preceding step. The following relation applies for the decomposition:

Ωₖ=RₖRₖ^{T}

By writing the new matrix Rₖ₊₁ as:

$${R}_{k + 1} = [ \begin{matrix}{R}_{k} & 0 \\ {r}^{T} & d\end{matrix} ]$$

the following applies:

$$[ \begin{matrix}{Ω}_{k} & ω \\ {ω}^{T} & o + {γ}^{- 1}\end{matrix} ] \begin{matrix}= [ \begin{matrix}{R}_{k} & 0 \\ {r}^{T} & d\end{matrix} ] [ \begin{matrix}{R}_{k}^{T} & r \\ 0 & d\end{matrix} ] \\ = [ \begin{matrix}{R}_{k}^{T} {R}_{k}^{T} & {R}_{k} r \\ {r}^{T} {R}_{k}^{T} & {d}^{2} + {r}^{T} r\end{matrix} ]\end{matrix}$$

From this equation we obtain the following relations:

Ωₖ=RₖRₖ^{T}

ω=Rₖr

o+γ⁻¹=d²+r^{T}r

The first relation shows that the preceding decomposition remains in the upper left-hand corner of the matrix. The vector r can be calculated as r=R⁻¹ₖω. The d is given as d=√(φ+γ⁻¹−rr^{T})

which is always positive because Ωₖ₊₁ is positive definite. The updating of the Cholevsky decomposition is hereby completed.

3. Recalculation of the α's and Bias

Rewrite

$$[ \begin{matrix}0 & {{1}^{->}}^{T} \\ {1 }^{->} & Ω + {γ}^{- 1} I\end{matrix} ] [ \frac{b}{σ} ] = [ \frac{0}{y} ] \\ as \\ [ \begin{matrix}\begin{matrix}{{1}^{->}}^{T} & {H}^{- 1} & \vec{1}\end{matrix} & 0 \\ 0 & H\end{matrix} ] [ \frac{b}{α + {H}^{- 1} \vec{1} b} ] = [ \frac{{{1}^{->}}^{T} {H}^{- 1} y}{y} ]$$

wherein H=(Ω+γ⁻¹I). The fact that H is positive definite can now be used. The solution of α and bias is given in the following steps:

a) Find the solutions o\tilde{f} η and ν from

Hη=T and Hν=y

making use of the Cholevsky decomposition.

b) Calculate

s=\vec{1}^{T}η

c) The solution is given by

bias=b=η^{T}y/s

α=ν−ηb

4. Update Cholevsky

A row and a column have to be removed from the matrix Ω and a new decomposition matrix R has to be calculated. Three cases are considered:

a) The last row/column is removed.

b) The first row/column is removed.

c) An arbitrary row/column is removed.

a) Removal of the Last Row/Column

In the part relating to the addition of a row/column it is the case that:

$$[ \begin{matrix}{Ω}_{k} & ω \\ {ω}^{T} & o + {γ}^{- 1}\end{matrix} ] \begin{matrix}= [ \begin{matrix}{R}_{k} & 0 \\ {r}^{T} & d\end{matrix} ] [ \begin{matrix}{R}_{k}^{T} & r \\ 0 & d\end{matrix} ] \\ = [ \begin{matrix}{R}_{k} {R}_{k}^{T} & {R}_{k} r \\ {r}^{T} {R}_{k}^{T} & {d}^{2} + {r}^{T} r\end{matrix} ]\end{matrix}$$

The upper left-hand matrix of the decomposition is not influenced by adding a column and a row to the matrix.

Assuming this, we can begin with the matrix

$$[ \begin{matrix}{Ω}_{k} & ω \\ {ω}^{T} & o + {γ}^{- 1}\end{matrix} ]$$

with its decomposition

$$[ \begin{matrix}R & 0 \\ {ρ}^{T} & r\end{matrix} ]$$

If the last row/column of the matrix is removed, the resulting decomposition will be the decomposition R. This means that if the outer right-hand column and corresponding lowest row are removed, the same row and column can be removed from the decomposition.

b) Removal of the First Row/Column

In order to determine how the decomposition changes, the matrix Ω changes to a new matrix:

$$[ \begin{matrix}o & {ω}^{T} \\ ω & Ω\end{matrix} ]$$

The corresponding new decomposition matrix is given by:

$$[ \begin{matrix}r & 0 \\ ρ & N\end{matrix} ]$$

The variables introduced herein have the same dimensions as the variables at corresponding positions in the above new matrix Ω.

The corresponding relations can be found by:

$$[ \begin{matrix}o & {ω}^{T} \\ ω & Ω\end{matrix} ] \begin{matrix}= [ \begin{matrix}r & 0 \\ ρ & N\end{matrix} ] [ \begin{matrix}r & {ρ}^{T} \\ 0 & {N}^{T}\end{matrix} ] \\ = [ \begin{matrix}{r}^{2} & r {ρ}^{T} \\ ρ r & {NN}^{T} + {ρρ}^{T}\end{matrix} ]\end{matrix}$$

which results in:

r²=o

ρr=ω

NN^{T}+ρρ^{T}=Ω

The last relation can be solved by means of a Cholevsky update. Rewriting of the last relation gives the following relations from which the update follows:

NN^{T}+ρρ^{T}=Ω

NN^{T}=Ω=ρρ^{T}

NN^{T}=RR^{T}−ρρ^{T}

Calculated in the above is how a decomposition can be updated if a row/column are added to the upper left-hand part. If the starting matrix is therefore given by

$$[ \begin{matrix}o & {ω}^{T} \\ ω & Ω\end{matrix} ]$$

and the first column and row are removed, the decomposition of

$$[ \begin{matrix}r & 0 \\ ρ & N\end{matrix} ]$$

changes to R with RR^{T}=NN^{T}+ρρ^{T}

c) Removal of an Arbitrary Row/Column

The concept of the above is now applied again. The original matrix is:

$$[ \begin{matrix}A & B \\ {B}^{T} & C\end{matrix} ]$$

The original decomposed matrix is given by:

$$[ \begin{matrix}R & 0 \\ P & Q\end{matrix} ]$$

The following relations apply:

A=RR^{T}

B=RP^{T}

C=PP^{T}+QQ^{T}

The new matrix is given by

$$[ \begin{matrix}A & α & B \\ {α}^{T} & a & {β}^{T} \\ {B}^{T} & β & C\end{matrix} ]$$

The decomposition thereof is:

$$[ \begin{matrix}R & 0 & 0 \\ {ρ}^{T} & τ & 0 \\ P & π & N\end{matrix} ]$$

The relations can now be determined from:

$$[ \begin{matrix}A & α & B \\ {α}^{T} & a & {β}^{T} \\ {B}^{T} & β & C\end{matrix} ] = [ \begin{matrix}{RR}^{T} & R ρ & {RP}^{T} \\ {ρ}^{T} {R}^{T} & {τ}^{2} + {ρ}^{T} ρ & {ρ}^{T} {ρ}^{T} + τ {π}^{T} \\ {PR}^{T} & ρρ + πτ & {PP}^{T} + {ππ}^{T} + {NN}^{T}\end{matrix} ]$$

RR^{T}=A

RP^{T}=B

Rρ=α

r²+ρ^{T}ρ=α

ρρ+πr=β

NN^{T}+ππ^{T}+PP^{T}=C

The first two relations are equal in this case and in the original case, so they remain the same. The vectors and scalars can be calculated by means of the added vector. The new matrix N is an update of the preceding matrix Q:

NN^{T}=C−ππ^{T}−PP^{T}

NN^{T}=PP^{T}+QQ^{T}−ππ^{T}−PP^{T}

NN^{T}=QQ^{T}−ππ^{T}

Now it is known how a row/column can be added, it is known how a row/column can be removed. If a row and a column are removed, the matrices R, P remain equal.

The matrix Q must be updated as:

QQ^{T}=NN^{T}+ππ^{T}

The updating of the Cholevsky matrix is of the highest order and this order is n². The complete recalculation of the decomposition is of the order n³.

The set of vectors is preferably now minimized. The criteria for omitting vectors have to be formulated carefully. It can generally be stated that the α's which are “too small” are suitable for removal from the set of vectors. The remaining vectors would then represent the function. Different criteria can be followed in order to establish when an a is too small. A number of criteria for the final result are:

a) the number of support vectors must be no larger than necessary,

b) the number of support vectors may not increase if more data points were represented in the same function.

c) the function must be represented sufficiently accurately. The degree of accuracy can be determined by the designer.

An example of a first criterion for reducing the number of vectors is to omit a vector if the ratio of the α thereof relative to the maximal α is smaller than a determined threshold value, for instance 0.2.

In practice the control system is implemented in software embedded in a computer. On the basis of this text a skilled person in the field will be able to write a computer program for performing the steps of the described method.

The invention is of course not limited to the discussed and shown preferred embodiments, but extends generally to any embodiment falling within the scope of the appended claims as seen in the light of the foregoing description and drawings.

1. Linear motor with a control system for controlling one or more components of the linear motor movable along a path, wherein the control system is provided with a function-approximator which is adapted to approximate one or more functions related to the movement of the components for the purpose of determining at least a part of a control signal, wherein the function-approximator operates in accordance with the “Support Vector Machine” principle.

2. Linear motor as claimed in claim 1, wherein the function-approximator operates in accordance with the least squares principle.

3. Linear motor as claimed in claim 2, wherein the function-approximator operates in accordance with an iterative principle.

4. Linear motor as claimed in claim 3, wherein a dataset with initial values to be inputted into the function-approximator comprises a minimal number of data which partially represents the movement of the movable components for controlling.

5. Method for controlling one or more components of a linear motor movable along a path, which motor is provided with a control system comprising a function-approximator, which method comprises the following steps of:
a) approximating one or more functions related to the movement of the components by means of the function-approximator;
b) determining at least a part of a control signal for the movable components on the basis of the functions approximated in step a); and
c) applying the “Support Vector Machine” principle in the function-approximator.

6. Method as claimed in claim 5, wherein the method further comprises the step of applying the least squares principle in the function-approximator.

7. Method as claimed in claim 6, wherein the method further comprises the step of having the function-approximator function iteratively.

8. Method as claimed in claim 7, wherein the method further comprises the step of feeding to the function-approximator a dataset with initial values which comprises a minimal number of data partially representing the movement of the components for controlling.

9. Control system for applying in a linear motor as claimed in any of the foregoing claims 1-4.

10. Computer program for performing the method as claimed in any of the foregoing claims 5-8.
